(19) United States
(12) Patent Application Publication
(10) Pub. No.: US 2024/0218613 A1
(43) Pub. Date: Jul. 4, 2024

(54) SYSTEMS AND METHODS FOR IDENTIFYING PAVED SURFACE FEATURES AND ESTIMATING REPAIRS

(71) Applicant: Crafco, Inc., Chandler, AZ (US)

(72) Inventors: Jarod Hanko, Jenison, MI (US); Austin Van Putten, Wyoming, MI (US)

(21) Appl. No.: 18/092,865

(22) Filed: Jan. 3, 2023

(51) Int. Cl. E01C 23/01; G06T 7/00; G06T 7/60; G06V 20/56; G06V 20/70

(52) U.S. Cl. CPC E01C 23/01; G06T 7/0002; G06T 7/60; G06V 20/56; G06V 20/70; G06T 2200/24; G06T 2207/30252; H04N 23/90

(57) ABSTRACT

Systems and methods for pave surface management are described. A paved surface surveying system can include one or more cameras coupled to a vehicle, a distance measurement system configured to selectively trigger the one or more cameras to capture digital images of the paved surface, and at least one processor. The at least one processor can be configured to receive the digital images, convert the digital images into input images each representing a portion of the paved surface at a particular point in time, determine using image recognition that each of a plurality of pixels of each input image meets or surpasses a similarity threshold to one of the pavement features, assign a label for each of the plurality of pixels based on the determination, and generate an estimate of material needed to repair the paved surface based on the assigned labels.

### TECHNICAL FIELD

The present disclosure relates to paved surface maintenance technology and, in particular, to systems for use in determining the extent of cracking on road segments and estimating materials required for repairs.

### BACKGROUND

With the development of modern road networks, the maintenance and management of pavement has become increasingly prominent. Conventionally, manual detection has been used to evaluate road conditions, such as holes and cracks in roads. In some conventional road condition management approaches, an engineer visually checks the number of cracks and calculates a crack ratio for each portion of road. These approaches suffer from low efficiency and interference of subjective factors, particularly when large road networks are considered.

Conventional approaches that have sought to remove the manual labor of road condition management often incorporate specially designed pavement detection vehicles or comprehensive rigs that require 3D cameras and sophisticated technology. The cost of these pavement detection vehicles is often prohibitively expensive for use in estimating repair cost for road segments. Furthermore, it can be difficult to achieve full coverage, high-frequency inspection of all levels of roads, resulting in insufficient decision support data for intelligent maintenance. Additionally, some conventional pavement detection systems require a shroud or cover of the road surface being analyzed, increasing cost and use complexity.

### SUMMARY

Accordingly, there is a need for high-frequency inspection equipment covering all levels of roads that can collect sufficient crack data for intelligent decision support of large road networks while reducing complexity and cost.

In one aspect, the present disclosure provides for a paved surface surveying system that identifies pavement features of a paved surface and estimates the length, width, and severity of pavement features and an amount of material needed to repair those pavement features. The paved surface surveying system includes one or more cameras coupled to a vehicle, a distance measurement system configured to selectively trigger the one or more cameras to capture digital images of the paved surface based on distance traveled by the vehicle, and at least one processor. The at least one processor is configured to receive the digital images, convert the digital images into input images with each input image representing a portion of the paved surface captured at a particular point in time, determine using image recognition that each of a plurality of pixels of each input image meets or surpasses a similarity threshold to one of the pavement features, assign a label for each of the plurality of pixels based on the determination, and generate an estimate of the length, width, and severity of pavement features of the paved surface based on the assigned labels.

In another aspect, the present disclosure provides for a pavement surveying method that identifies pavement features of a paved surface and estimates material needed to repair the paved surface. The method includes capturing digital images of the paved surface with one or more cameras coupled to a vehicle based on distance traveled by the vehicle, converting the digital images into input images with each input image representing a portion of the paved surface captured at a particular point in time, determining using image recognition that each of a plurality of pixels of each input image meets or surpasses a similarity threshold to one of the pavement features, assigning a label for each of the plurality of pixels based on the determination, and generating an estimate of material needed to repair the paved surface based on the assigned labels.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system for portable pavement repair estimation according to an embodiment.

FIG. 2 is a perspective view of a camera mounting rig for portable pavement repair estimation according to an embodiment.

FIG. 3 is a user interface according to an embodiment.

FIG. 4 is a top-down view of a images stitched together using ArUco markers according to an embodiment.

FIG. 5A is a top-down view of an image of pavement segment according to an embodiment.

FIG. 5B is a top-down view of detected cracks present within the image of FIG. 5A.

FIG. 6A is a top-down view of an image of pavement segment according to an embodiment.

FIG. 6B is a top-down view of detected cracks and not-pavement present within the image of FIG. 6A.

FIG. 7 is a generated report of crack density for a roadway according to an embodiment.

FIG. 8 is a web interface according to an embodiment.

FIG. 9 is a flowchart of a method for acquiring and processing pavement images according to an embodiment.

FIG. 10 is a flowchart of a method for analyzing composite images of pavement segments according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Embodiments of the present disclosure include a portable pavement repair estimation system that uses one or more camera inputs to output an estimate of volume of materials required to perform pavement repair incorporating a visual system configured to combine the views of multiple cameras positioned around a vehicle to detect cracks and other anomalies in pavement while moving.

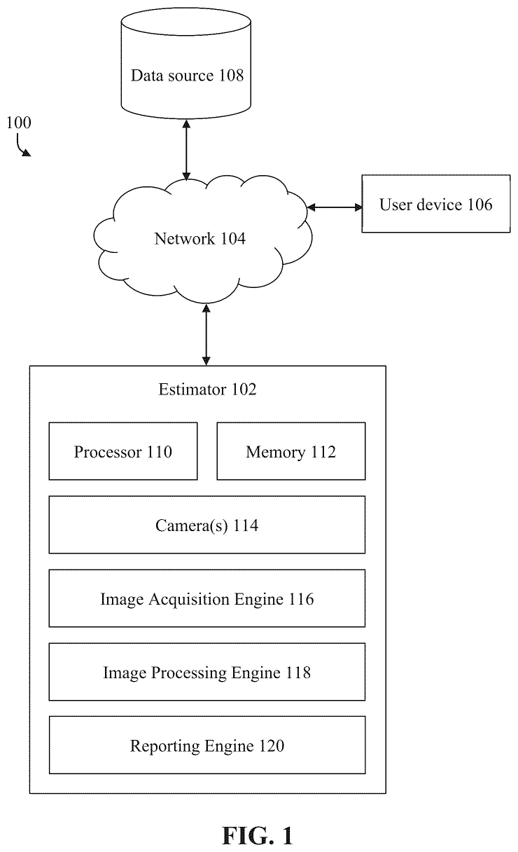

Referring to FIG. 1, a block diagram of a system 100 for portable pavement repair estimation is depicted, according to an embodiment. System 100 can be used to estimate a volume of materials and time required to perform pavement repair for a road segment and generally comprises estimator 102, network 104, user device 106, and data source 108.

In embodiments, estimator 102 can be portable hardware configured to mount on a vehicle and provide distance tracking, triggering, and image acquisition. Estimator 102 generally comprises processor 110, memory 112, one or more cameras 114, and one or more engines, such as image acquisition engine 116, image processing engine 118, and reporting engine 120.

Estimator 102 can be a mounted system for a preexisting vehicle or be permanently incorporated into a special purpose vehicle. Estimator 102 is configured to track distance of the vehicle, capture imagery at set distances, stitch imagery from multiple cameras, analyze imagery for road features using machine learning, determine feature statistics from imagery, and provide an actionable summary of the data collected. For example, estimator 102 can include distance tracking hardware (e.g., radar, inertial measurement unit (IMU), encoder) communicatively coupled to a microcontroller, such as processor 110, that can trigger image acquisition of pavement segments from one or more mounted cameras. The acquired images can then be run through a machine learning (ML) pipeline to identify pavement features and to estimate necessary repair materials for the pavement segments. The term “estimator” will be used herein throughout for convenience but is not limiting with respect to the actual features, characteristics, or composition of any automated sensing system that could embody estimator 102.

Processor 110 can be any programmable device that accepts digital data as input, is configured to process the input according to instructions or algorithms and provides results as outputs. In an embodiment, processor 110 can be a central processing unit (CPU) or a microcontroller or microprocessor configured to carry out the instructions of a computer program. Processor 110 is therefore configured to perform at least basic arithmetical, logical, and input/output operations.

Memory 112 can comprise volatile or non-volatile memory as required by the coupled processor 110 to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, or optical disc storage, for example. The foregoing lists in no way limit the type of memory that can be used, as these embodiments are given only by way of example and are not intended to limit the scope of the present disclosure.

Camera 114 refers to any device capable of capturing, detecting, or recording images. Camera 114 can be a single camera or a camera array comprising two or more cameras. In embodiments, cameras 114 are three mono (black and white) cameras. In some embodiments, camera 114 can include an image sensor or a combination of image sensors. Camera 114 can be configured to capture and store digital images. Any images produced by camera 114 can be transmitted to processor 110 and/or one or more engines of estimator 102 for analysis.

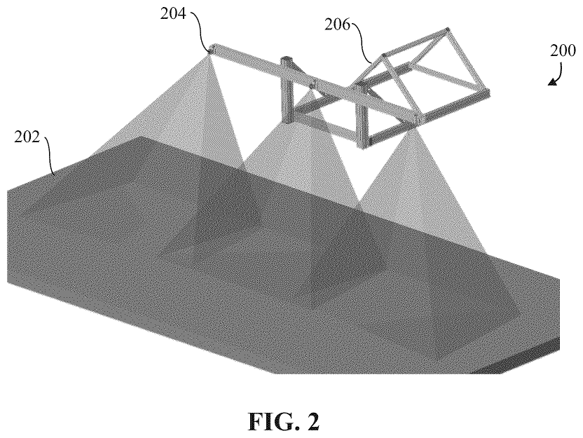

Referring to FIG. 2, a camera mounting system 200 that can be used to support cameras 114 of system 100 is depicted according to an embodiment. Camera mounting system 200 can be mounted on a vehicle (not shown) to capture images of a pavement surface 202 with cameras 204 mounted on frame 206. In embodiments, three mono 2D cameras 204 can be spaced apart on frame 206 and the area of pavement captured by images can be 4 feet by 17 feet. In some embodiments, cameras 204 can be mounted inside waterproof enclosures. Frame 206 can be constructed from one or more of metals, woods, or plastics. In an embodiment, frame 206 comprises aluminum.

The wide area of pavement segment that can be captured by embodiments of the present disclosure represents an improvement over conventional imaging solutions that require a shroud or cover to eliminate shadows over the pavement segment. Existing solutions that require a more controlled lighting environment generally cannot be used to capture such a large area as a shroud of that size would not be feasible on many roads and highways, particularly at higher speeds. Embodiments of the present disclosure overcome this obstacle through the incorporation of particular camera settings, that when combined with the image stitching capabilities described herein, enable more efficient image capturing over larger areas. Particular camera settings (e.g., exposure time, gain, sensor size, target gray) in combination with the ML model remove the need for a shroud. The images captured are still affected by shadows, but the model is trained to still find cracking in the shadow such that the shadow can be effectively ignored. Statistical sampling can also be used such that a single image that is over or under exposed can be discarded without a significant effect on the overall system.

With continued reference to FIG. 1, estimator 102 includes image acquisition engine 116, image processing engine 118, and reporting engine 120. The use of the term “engine” herein refers to any hardware or software that is constructed, programmed, configured, or otherwise adapted to autonomously carry out a function or set of functions, such as detecting a user device 106 or communicating with data source 108. Engine is herein defined as a real-world device, component, or arrangement of components implemented using hardware, such as by an application specific integrated circuit (ASIC) or field programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations and should generally not be limited to any particular implementation exemplified herein, unless such limitations are expressly called out.

In embodiments, each engine can itself be composed of more than one sub-engine, each of which can be regarded as an engine in its own right. Moreover, in the embodiments described herein, each of image acquisition engine 116, image processing engine 118, and reporting engine 120 correspond to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

System 100 can be implemented irrespective of the number or type of engines. In embodiments, image acquisition engine 116, image processing engine 118, and/reporting engine 120 can be within or outside the structure of estimator 102, such as being stored in a housing independent of a camera mount. For example, image processing engine 118 can be located at a server remote from hardware mounted on a vehicle.

Image acquisition engine 116 is configured to calibrate and operate camera 114 and maintain a sensor log. Camera calibration can include one or more of implementing coded calibration functions, lens distortion correction, converting images to a top-down view to remove camera angles, stitching across cameras using markers, and cropping. In embodiments, calibration is done each time estimator 102 is mounted to a new vehicle. Stitching of images as used herein primarily refers to stitching the side-by-side camera views at a single location. However, in some embodiments stitching sequential views as the camera travels down the road can also be carried out. In embodiments stitching could also be done between multiple runs (side to side) so that multiple lanes can be stitched together to generate a complete map of a road, parking lot, or other paved surface.

Image processing engine 118 is configured to import images, process images (e.g., dewarping, stitching, equalizing, cropping), and conduct semantic segmentation and skeletonization. In embodiments, image processing engine 118 can implement machine learning models for semantic segmentation and inference as will be described later.

Reporting engine 120 is configured to support customizable queries to summarize image statistics over various intervals and include a web interface to generate an actionable report of pavement status. The report can include a high-level summary with one or more of location surveyed (e.g., a map of surveyed roads and lanes whether historical or current), the length and width of cracking, density of cracks over the pavement length, and estimated sealant quantity to repair the detected pavement anomalies.

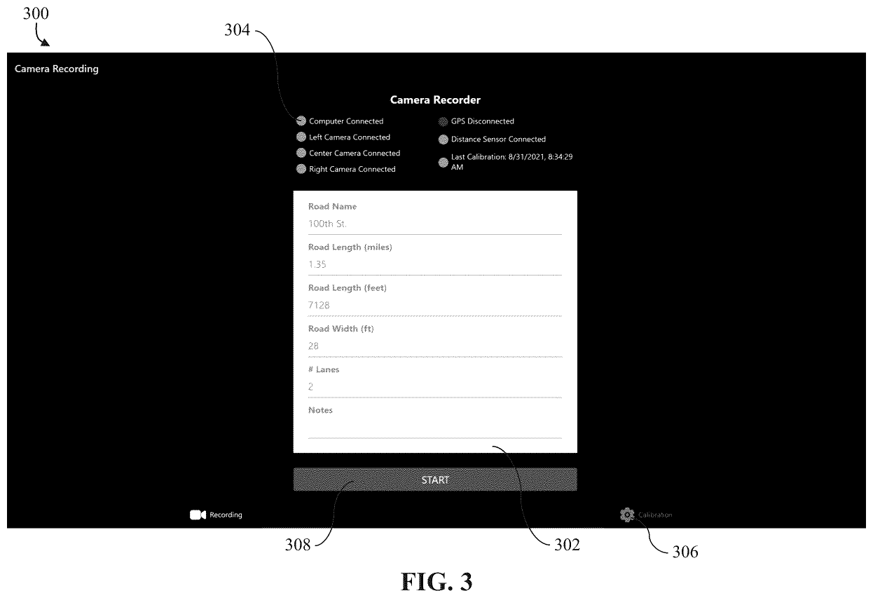

Referring to FIG. 3, estimator 102 can include user interface 300 according to embodiments. User interface 300 can include data fields 302 configured to receive user inputs and provide user outputs regarding configuration and status of estimator 102. In some embodiments, user interface 300 can comprise a mobile application, web-based application, or any other executable application framework. In such embodiments, user interface 300 can reside on, be presented on, or be accessed by any computing devices capable of communicating with the various components of system 100, receiving user input, and presenting output to the user. In embodiments, the user interface 300 can be presented on user device 106 within a vehicle to which cameras 114 are mounted. In such embodiments, user interface 300 can display diagnostic information, such as status indicators 304, to a driver or passenger of the vehicle so that system information can be monitored during use.

User interface 300 can support data entry including road information (e.g., road name, location, length, width, or geographic area) and camera information (e.g., number of lenses, type of cameras) via data fields 302 and display the current connection status of one or more cameras, distance sensor, GPS, and computers via status indicators 302. The user interface can additionally enable system control, such as enabling a user to run calibration and access calibration information via calibration button 306 and start, pause, or stop image acquisition using record button 308. In embodiments, users can add a map of surveyed roads, a live video feed, or retrieve static images via the user interface.

Estimator 102 is configured to provide two-way data communication with network 104 via a wired or wireless connection. The specific design and implementation of an input/output engine of estimator 102 can depend on the communications network(s) over which estimator 102 is intended to operate. Estimator 102 can, via network 104 or a wired connection, access stored data from at least one data source 108.

In embodiments, network 104 can be in communication with a server, such as a cloud-based server, that can include a memory and at least one data processor. In addition, the server can collect and retrieve data from one or more external sources, such as a variety of navigational services or user management services. The one or more external sources can assist the server with providing estimator 102 with GPS information associated with estimator 102 in real-time. In embodiments, the one or more external sources can collect a variety of data from estimator 102 that can include one or more of captured images, road information, and the like. In embodiments, a cellular connection can be used to connect to a remote server.

User device 106 generally comprises processing and memory capabilities and can establish a wireless or wired connection with network 104 or otherwise communicate to estimator 102, such as by Bluetooth. Examples of user device 106 include smartphones, tablets, laptop computers, wearable devices, other consumer electronic devices or user equipment (UE), and the like. The term “user device” will be used herein throughout for convenience but is not limiting with respect to the actual features, characteristics, or composition of the or any device that could embody user device 106. In embodiments, user device 106 can run an instance of the user interface designed to facilitate user interaction with one or more features of estimator 102. In embodiments, user device 106 can be associated with one or more user profiles.

In one aspect, user device 106 can have a wired connection to estimator 102 such that connecting via network 104 is not necessary. This arrangement can be useful when user device 106 is located in a vehicle with estimator 102 as user device 106 can store captured images that will later be uploaded to data source 108 or a remote processing server. In embodiments, user device 106 can be a laptop in a truck on which cameras 114 are mounted.

Data source 108 can be a general-purpose database management storage system (DBMS) or relational DBMS as implemented by, for example, Oracle, IBM DB2, Microsoft SQL Server, PostgreSQL, MySQL, SQLite, Linux, or Unix solutions. Data source 108 can store one or more data sets associated with user devices 106. In embodiments, data source 108 can be native to estimator 102 such that no connection to network 104 is necessary.

One purpose of data source 108 is to associate navigational data, such as GPS coordinates, with captured images such that reports can be compared for different road segments, as necessary. Location information communicated to estimator 102 can be an effective way to compare pavement conditions along roads and provide estimates of repair costs.

In operation, image acquisition engine 116 can acquire images via camera 114 based on distance traveled by estimator 102 as determined by one or more wheel sensors and/or radar based measurements. In embodiments, using one or more wheel sensors mounted to a wheel hub of a vehicle upon which estimator 102 is mounted a quadrature encoder driven distance measurement can be used to trigger photo acquisition. In such embodiments, calibration involves developing a pulse per meter unit. In other embodiments, or to improve the accuracy of embodiments incorporating wheel sensors, a radar-based distance measurement can be used. A radar, such as an agriculture doppler radar, can be used in conjunction with an accelerometer and extended Kalman filter for sensor fusion to estimate the velocity of estimator 102 and then integrate for distance. Calibration of this distance determining method can be accomplished by operation with an encoder and calculation of a correction term. In embodiments, a global navigation satellite system (GNSS) can be used for location tracking.

Based on this distance information, image acquisition engine 116 sends a hardware trigger signal to cameras 114 each time a set distance is traveled. The set distance is based on the field of view of images captured by cameras 114 as determined during calibration. Image acquisition engine 116 can further log GPS points at the time the hardware trigger signal is sent such that captured images are mapped to locations along pavement segments.

In embodiments, three cameras 114 each capture sequential images of a pavement surface that are stored in separate video files. Calibration data can later be used to stitch images from each camera for a particular point in time into a single image for analysis. In embodiments utilizing three mono cameras about 1 mm² of pavement surface can be represented per image pixel and images of approximately 49 inches by 17 feet can be produced. Image acquisition engine 116 can upload imagery and GPS data logged by system 100 to a backend pipeline for processing by image processing engine 118.

Image processing engine 118 is configured to detect new jobs and analyze video files frame by frame. Each frame is dewarped, deskewed, and transformed to a top-down view before the frames are stitched together and cropped into a single image.

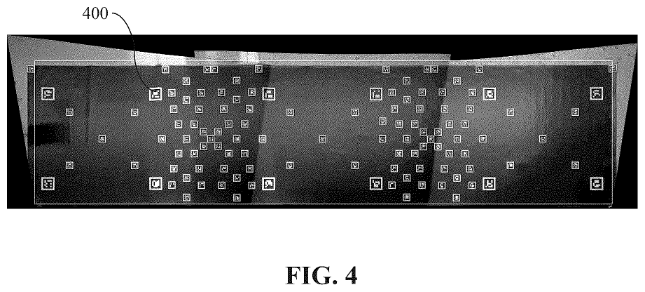

Stitching across cameras can be accomplished using ArUco markers as shown in FIG. 4. ArUco markers 400 are synthetic square markers composed of a wide black border and an inner binary matrix which determines its identifier. These identifiers can be compared by image processing engine 118 such that each image can be overlaid on one another to create a single composite image. For example, FIG. 4 depicts three images that have been stitched together. Image processing engine 118 can then crop the stitched images for more efficient analysis. Stitched images can also be equalized to improve contrast and consistency of imagery.

Embodiments of the present disclosure implement artificial intelligence (AI) or machine learning (ML) to image segmentation, inference, and skeletonization of 2D images of pavement cracks such that a single pixel-width network of cracks can be generated for each pavement segment. In particular, the inventors have discovered that a unique combination of image data acquisition, handling, and processing can produce detailed analysis of crack widths, lengths, depths, and density such that hardware requirements and implementation complexity of conventional solutions are reduced. The use of 2D cameras as opposed to 3D cameras is representative of this reduction in complexity.

Visual characteristics of pavement conditions can be extracted manually or automatically by machine learning approaches such as, for example, convolutional neural networks, to produce labeled images on a pixel-by-pixel basis. These visual characteristics can be determined by image processing engine 118 and can each be associated with a particular crack network and stored in data source 108 for future visual characteristic recognition. Such analysis can be accomplished through associating each pixel with a numerical value based on at least one of color or grayscale of the pixel. A neural network configured to determine a probability of the pixel representing at least a portion of a pavement feature can then assign labels to each pixel based on these numerical values and comparisons to trained data. In embodiments, labels can include one or more of crack, grass, pavement, not-pavement, concrete, paint, and the like. Accordingly, the ML model can be efficiently applied to labelled (supervised) image data by image processing engine 118. In embodiments, unlabeled (unsupervised) image data can be used although accuracy and precision of the ML model will perform comparatively worse without more extensive training.

In embodiments, training data can include a plurality of images having labeled cracks occurring at different locations within the image. With sufficient training from such examples the ML model can better recognize when visual characteristics of an image may belong to pavement variances rather than actionable cracks or other anomalies. In embodiments, the comparison process can be accomplished by computing similarity metrics using correlation or machine learning regression algorithms. For example, if the similarity of a pixel to the crack label is above a certain threshold, (e.g., 75%, 90%, 95% or 99% similarity) the matching process can determine that the pixel represents a crack in the pavement and the crack label can be assigned. This analysis can be improved during operation by inclusion of feedback loops directed to classifying visual characteristics of cracks based on determined accuracy of previously assigned labels. As more comparisons between images and labeled data are made, visual characteristic data (i.e., length, width, and depth of cracks) can be tracked to better recognize the starting and ending points of cracks within an image.

In embodiments, image processing engine 118 can implement one or more classifiers to consider parameters such as type of image (a mono image compared to a color image may have different parameters or visual characteristics for example) and type of pavement.

Image processing engine 118 can be trained to trim visual characteristics that are assigned the not-pavement label. In embodiments, the trimming process can determine that the column of pixels represents not-pavement, based on assigned labels, and can be trimmed. In embodiments, this process can be completed by comparing columns of pixels inwards from the left and right boarders of the image and/or by comparing rows of pixels inwards from the top and bottom boarders of the image. In such embodiments, the trimming can be stopped once the test fails from one or all sides. The area of pavement captured can also be logged and possibly trimmed if some threshold percentage of pixels is labeled not-pavement in a continuous block.

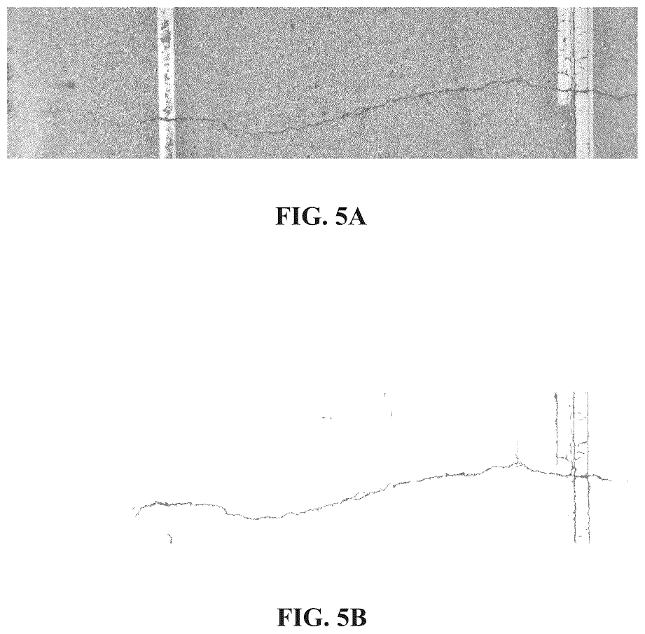

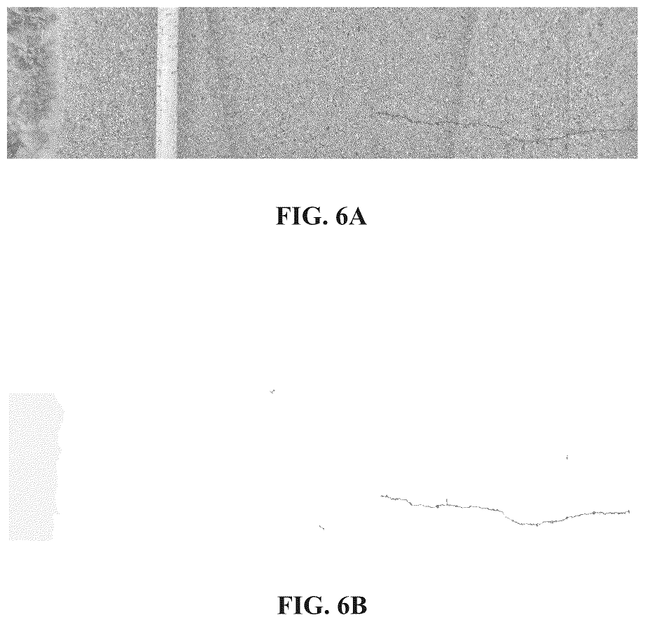

Referring now to FIGS. 5A and 6A, sample images of pavement segments with cracks and non-pavement (see left side of FIG. 6A) are depicted. FIGS. 5B and 6B depict images of FIGS. 5A and 6A respectively after being run through the ML pipeline such that only the pixels assigned the crack label and non-pavement (see left side of FIG. 6B) are depicted.

The required threshold for a pixel to be labeled a crack can be altered. Such an arrangement can improve crack recognition in situations where the system is attempting, yet repeatedly failing, to produce a sufficiently labeled image. In embodiments, one or more feedback loops can alter parameters of the image recognition ML model to personalize the labeling experience for different pavement types, camera arrangements, and the like. Parameters can include one or more of intensity of the matching threshold and whether the matching threshold is changed universally or for only one or more labels identified as being problematic.

With continued reference to FIG. 1, data across all the images for a road segment are extrapolated to the known area of road surface by image processing engine 118 and can be adjusted according to ratio of imaged area over the road area. Collected data is assumed to be a large statistical sampling of roadway and crack branches can be filtered based on width or other criteria. Depth can be determined based on a function of crack width. Portions of collected images can be weighted differently to reduce the impact of overlapping imagery using the known width of the road and the detected side of the road (if any). Image processing engine 118 can generate an estimated volume of sealant using visual characteristics of detected cracks (e.g., length, fuzzy length, depth) and entered sealant parameters.

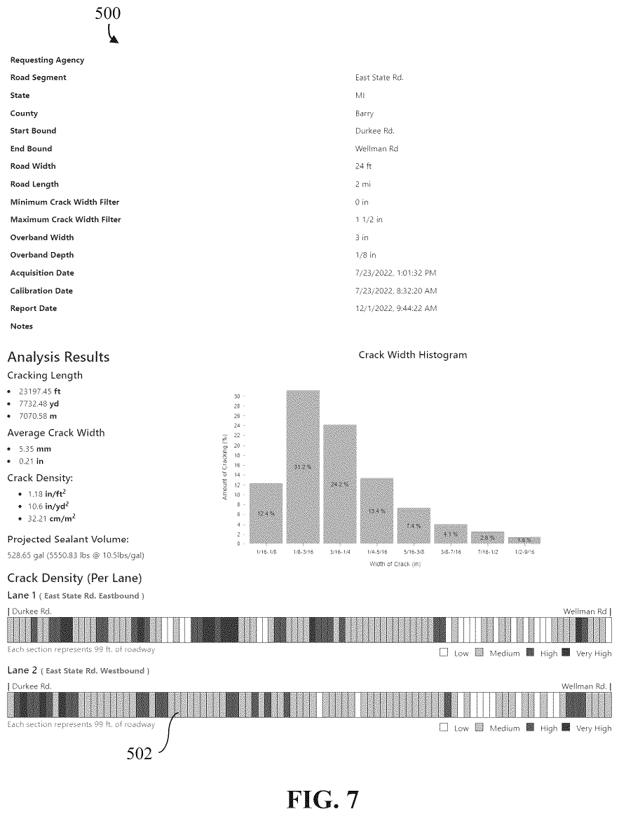

Reporting engine 120 can comprise a flexible web portal that provides data reports and filtering capabilities. Generated reports, such as report 500 depicted in FIG. 7, can include, location, surveyed length and width of cracking, density of cracking over road length, and estimated sealant quantity required to remedy cracks. In embodiments, only cracks of a certain width range are considered when determining required sealant and cracks not wide enough or too wide are filtered out. Although reduced to single pixel width for measuring length, the width of each crack is stored for use in calculating volume of material needed. Crack density over the length of a pavement segment can be represented graphically as shown by bars 502 in FIG. 7.

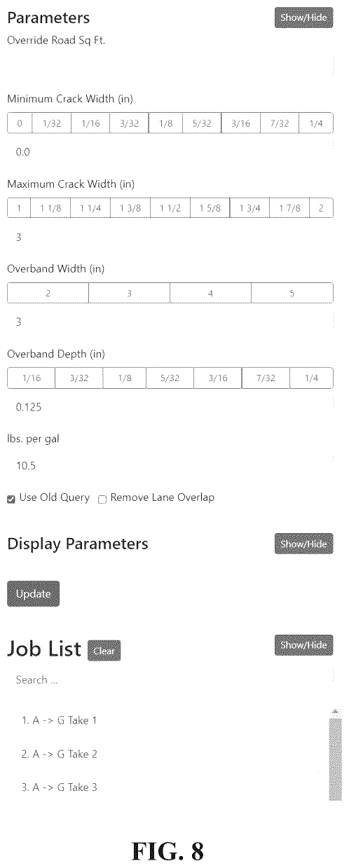

FIG. 8 depicts a user interface of a flexible web portal that allows a user to filter collected pavement data based on one or more parameters. Parameters can include one or more of size of road, minimum crack width, maximum crack width, overband width, overband depth, pounds per gallon, and the like. Additionally, particular road segment collecting periods or “jobs” can be filtered such that only certain jobs are visible or considered when generating a report.

Embodiments of the present disclosure limit labor required to survey pavement segments, provide for an efficient business pipeline, and allow for estimates to be generated directly from produced reports. In particular, estimates provided by the present disclosure can be used by contractors to make competitive bids for projects, reduce surveying time, minimize project risk by forecasting expected costs, and enable post-seal quality control.

System 100 represents an improvement over conventional pavement surveying approaches that fail to efficiently isolate and leverage 2D image data. Location data can be used to help estimate pavement repairs for precise road segments that require the most attention and allow for deterioration tracking. In particular, crack density can provide an effective measure of determining whether a section of roadway needs to be repaired or not. Additionally, system 100 provides automated surveying of road segments that can reduce uncertainty of the overhead cost of maintaining roads through data informed estimates of sealant material. Because system 100 can be implemented with 2D cameras, system 100 can realize lower cost and reduced data storage and processing requirements compared to conventional solutions.

Moreover, system 100 overcomes the shortcomings of conventional systems that require a shroud to limit lighting differences over the pavement segments being analyzed. Embodiments of the present disclosure can more effectively account for variances in lighting based on both the camera settings used (and the implementation of 2D cameras) and the ML model being trained to recognize and ignore variances caused by differences in lighting.

System 100 can also be used to audit the quality of a specific crack seal job by comparing the total cracking before and after treatment. This concept can be extended to tracking the value of various surface treatment options over time, such as surveying the total cracking before treatment, shortly after treatment, 1 year after treatment, 2 years after treatment, and so on. Types of treatment applied to similar pavement segments can be compared (e.g., a crack seal, a chip seal, double chip seal, fog seal). Accordingly, system 100 can be used to evaluate a road network and to recommend the appropriate treatment for portions of the road network most in need.

System 100 can also be applied to non-linear pavement areas, such as parking lots or airports. The hyper-precise location capabilities of system 100 combined with surface analysis can estimate the area of specific pavement segments to single centimeter level accuracy. This estimation is particularly beneficial for engineering estimates of pavement management options that are based on pavement area, not crack area, including chip seal and fog seal. The accuracy of system 100 can be utilized to generate a true complete crack map of a road segment.

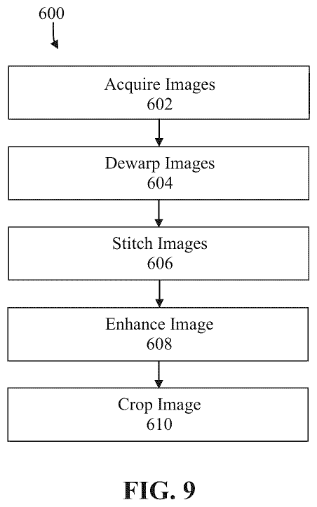

Referring now to FIG. 9, a flowchart of a method 600 for acquiring and processing pavement images is depicted. Method 600 can be implemented by system 100 such as via estimator 102.

At 602 images are acquired from a system including, for example, three cameras mounted on a moving vehicle. In embodiments, the system acquires images as the system is driven down a roadway. The process of capturing each image is timed such that no portion of the pavement segment is missed between images. In some embodiments, the images for each roadway are saved as a video. The video files can then be automatically or manually transferred to a server or data store.

At 604 the three separate images acquired by each camera at a given location are dewarped. The dewarp process is based on a static camera and lens parameters. The calibration routine calculates the required transformation to make a single composite top-down image from the 3 individual cameras, accounting for the variations between vehicles and the angled mounting of the cameras. This transformation is determined by analyzing a teaching grid placed on the ground. The grid has several markers, which the system locates and identifies. The calibration routine looks for the markers that are stored with a specific location and from that information the necessary transformation to correct for the skewing of the camera.

At 606 the three camera images are stitched (combined) into a corrected composite image of the road. Notably, in embodiments this stitching is of images captured simultaneously, or near-simultaneously, between the three cameras. Subsequent images from each camera are not stitched together in some embodiments. In embodiments, each combined image is approximately a 17 ft by 4 ft image.

At 608 the composite image of the road can be enhanced, such as by equalization to improve contrast and consistency of imagery.

At 610 the composite image is cropped to remove portions that are not pavement.

Although described with respect to three cameras, method 600 can be applied to any system incorporating one or more cameras.

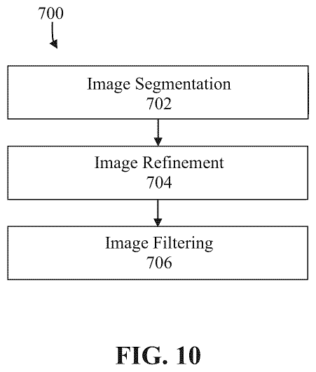

Referring now to FIG. 10, a method 700 for analyzing composite images of pavement segments is depicted according to an embodiment. In embodiments, method 700 can be applied to a composite image such as that produced by FIG. 9.

At 702, an image is broken down into smaller images that are run through a ML pipeline. The ML pipeline applies image segmentation to identify which pixels are crack, pavement, not-pavement (i.e., not-road), and sealant. The ML pipeline identifies pixel patterns by comparisons to training data sets.

At 704 the image is run though a refinement process including skeletonization to isolate crack segments from pavement. The refinement process can include removal of gaps within crack networks to correct for debris. The output of ML pipeline is then characterized by length, width, location, and other information for each crack network and saved to a database.

At 706 a user interface allows a user to filter images. The user can select a specific road segment for which the associated crack data is retrieved from the database. The user interface can allow a user to filter cracks based on characterizations (e.g., length, width). In embodiments, the user interface generates a report based on the data stored in the database and filters applied by the user.

It should be understood that the individual operations used in the methods of the present teachings may be performed in any order and/or simultaneously, as long as the teaching remains operable. Furthermore, it should be understood that the apparatus and methods of the present disclosure can include any number, or all, of the described embodiments, as long as the teaching remains operable.

Embodiments of the present disclosure allow users to quickly determine the extent of cracking on road segments, allowing a data-driven estimating and bidding process. Road segment data generated by embodiments of the present disclosure can be used to generate a treatment demand map and estimated costs to inform future placement or maintenance of roads. The pavement surveying system realizes millimeter-level road feature analysis to measure total length, width, and density of cracking, all in a simple, easy-to-use, and quick-to-operate manner.

The ability to filter by cracks that meet specified size criteria, understand the cracking density over the length of the roadway, visualize the projected volume of sealant required for each job, and to easily incorporate the hardware system to an existing vehicle represent improvements over various conventional solutions. The hardware system can acquire images at full highway speeds without losing accuracy. In embodiments, the vehicle can be a drone or unmanned vehicle. In embodiments, the analysis could also be done using externally obtained and imported imagery as long as necessary parameters were provided (e.g., size of pixel, area of roadway being analyzed).

In one aspect, a system for estimating materials and application time in the repair of features, cracks or other fissures in paved surfaces can include a vehicle mounted frame supportively coupled to one or more cameras, a camera triggering system including at least one of a wheel encoder, a GNSS, an inertial measurement unit (IMU), or radio detection and ranging equipment configured to selectively trigger the one or more cameras for the capture of adjacent digital images of a paved surface, and a computer processor. The computer processor can be configured to receive the captured adjacent digital images, execute an algorithm to stitch the captured adjacent digital images into a digital input image, and assign each of a plurality of pixels within the digital input image a numerical value based on at least one of color or grayscale for further processing. A neural network operating on the computer processor can be configured to determine a probability of the pixel representing at least a portion of a feature, crack or other fissure in the paved surface, wherein the probabilities determined by the neural network are used to estimate materials and material application time needed for repair of the paved surface. The system can further comprise a remote server configured to store and analyze the cumulative statistics and present one or more statistics in a web application according to embodiments.

In embodiments, the vehicle mounted frame is configured to at least one of fit within the bed of a standard sized pickup truck, mount on a trailer. or mount to at least one of a front or rear bumper, roof or bed rack, or hitch receiver of a motorized vehicle.

In embodiments, the neural network is trained by dataset images wherein each pixel is annotated with one or more numerical values representing at least one of a feature, crack or other fissure. The neural network can include an input layer, an output layer, and at least one hidden layer, wherein each of the layers comprise a plurality of neurons. In such embodiments, each of the plurality of neurons are assigned an initial bias value and each of a plurality of connections between neurons of the layers are assigned an initial weight value. The initial bias values and the initial weight values can be tuned and refined as the neural network learns to properly identify features, cracks or other fissures in paved surfaces. An output value of each of the plurality of neurons is computed according to one of a linear function, sigmoid function, tanh function, rectified linear unit.

In embodiments, a cost function can be used to establish a deviation of the actual output data of the output layer to the known outputs of the training data, wherein over the course of several epochs, the weights and balances of the neural network are tuned to iteratively minimize the cost function.

In embodiments, the neural network is organized as a convolutional network wherein one or more groups of neurons within a layer are coupled to a single neuron of subsequent layer, wherein each of the groups has a shared weighted value.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A system for identifying pavement features of a paved surface, comprising:
one or more cameras coupled to a vehicle;
at least one processor configured to:
selectively trigger the one or more cameras to capture digital images of the paved surface;
convert the digital images into input images, each input image representing a portion of the paved surface;
determine, using image recognition, that each of a plurality of pixels of each input image meets or surpasses a similarity threshold to one of the pavement features;
assign a label for each of the plurality of pixels based on the determination; and
generate an estimate of an amount of pavement features of the paved surface based on the assigned labels.

2. The system of claim 1, wherein the digital images are captured based on distance traveled by the vehicle.

3. The system of claim 1, wherein the processor is further configured to generate an estimate of material needed to repair the paved surface based on the assigned labels.

4. The system of claim 1, wherein the amount of pavement features is one or more of length, width, and severity.

5. The system of claim 1, wherein the labels are one or more of crack, pavement, and not-pavement.

6. The system of claim 5, wherein the at least one processor is further configured to identify one or more crack branches based on the proximity of each crack label.

7. The system of claim 6, wherein the at least one processor is further configured to determine, for each crack branch, one or more of an average branch width, a branch, a branch length, and a crack density of the paved surface.

8. The system of claim 1, wherein the one or more cameras are three cameras configured to take adjacent digital images.

9. The system of claim 1, further comprising a data store, wherein the at least one processor is further configured to, after assigning a label for each of the plurality of pixels, store the input images and assigned labels in the data store.

10. The system of claim 1, further comprising a user interface configured to present the estimate of material.

11. A method for identifying pavement features of a paved surface, comprising:
capturing digital images of the paved surface with one or more cameras coupled to a vehicle, the capturing being triggered based on distance traveled by the vehicle;
converting the digital images into input images, each input image representing a portion of the paved surface captured at a particular point in time;
determining, using image recognition, that each of a plurality of pixels of each input image meets or surpasses a similarity threshold to one of the pavement features;
assigning a label for each of the plurality of pixels based on the determination; and
estimating an amount of pavement features based on the assigned labels.

12. The method of claim 11, wherein distance traveled by the vehicle is determined by at least one of a wheel encoder, an inertial measurement unit (IMU), or a global navigation satellite system (GNSS).

13. The method of claim 11, further comprising generating an estimate of material needed to repair the paved surface based on the assigned labels.

14. The method of claim 11 wherein the amount is one or more of length, width, and depth of pavement features.

15. The method of claim 11, wherein the labels are one or more of crack, pavement, and not-pavement.

16. The method of claim 15, further comprising identifying one or more crack branches based on the proximity of each crack label.

17. The method of claim 16, further comprising determining, for each crack branch, one or more of an average branch width, a branch, a branch length, and a crack density of the paved surface.

18. The method of claim 11, wherein the one or more cameras are three cameras configured to take adjacent digital images.

19. The method of claim 11, further comprising displaying the estimate of material on a user interface.

20. A non-transitory computer-readable storage medium storing executable instructions that when executed on a processor, cause the processor to carry out the method of claim 11.
